(19) United States
(12) Patent Application Publication
(10) Pub. No.: US 2022/0349455 A1
(43) Pub. Date: Nov. 3, 2022

(54) FRICTION TRANSMISSION BELT

(71) Applicant: BANDO CHEMICAL INDUSTRIES, LTD., Kobe-shi (JP)

(72) Inventors: Yuya SHINDO, Kobe-shi (JP); Shogo KOBAYASHI, Kobe-shi (JP)

(73) Assignee: BANDO CHEMICAL INDUSTRIES, LTD., Kobe-shi (JP)

(21) Appl. No.: 17/717,482

(22) Filed: Apr. 11, 2022

(30) Foreign Application Priority Data
Apr. 30, 2021 (JP) 2021-077767

(51) Int. Cl. F16G 5/08; F16G 5/20

(52) U.S. Cl. CPC F16G 5/08; F16G 5/20

(57) ABSTRACT

A friction transmission belt includes a belt body which transmits power to a pulley. In a relationship between a friction coefficient and a slipping speed which is a difference between a speed of the belt body and a speed of the pulley, when a slipping speed at which a maximum friction coefficient is indicated is defined as a first slipping speed, a friction coefficient when the slipping speed is increased from the first slipping speed to a second slipping speed is defined as a reference friction coefficient, and a difference between the second slipping speed and the first slipping speed is 500 mm/s, a decrease rate Dm of the friction coefficient indicated by the following equation (1) with the maximum friction coefficient being denoted by μx and the reference friction coefficient being denoted by μr is not greater than 20%.

Dm=(μx−μr)/μx×100 (1)

### TECHNICAL FIELD

The present invention relates to a friction transmission belt.

This application claims priority on Japanese Patent Application No. 2021-077767 filed on Apr. 30, 2021, the entire content of which is incorporated herein by reference.

### BACKGROUND ART

Conventionally, as a means for transmitting rotational power of an engine, a motor, or the like, a method in which pulleys are fixedly provided on rotation shafts on a driving side and a driven side, respectively, and a friction transmission belt such as a V-ribbed belt is trained around each pulley, has been widely used.

It is known that a friction transmission belt (hereinafter, referred to as transmission belt) causes a phenomenon called stick-slip when being exposed to water during operation, and this phenomenon may be accompanied by generation of abnormal sound, in other words, slip sound. The slip sound of the transmission belt causes noise of a device, so that various countermeasures have been considered.

For example, PATENT LITERATURE 1 proposes that for a friction transmission belt in which the surface on the pulley contact side of a belt body is covered with a knitted fabric, the knitted fabric is formed from a yarn that extends while inverting the extending direction thereof so as to reciprocate in the width direction of the friction transmission belt and that has inversion portions inverting the extending direction and straight portions connecting and extending between the inversion portions, and the surface on the pulley contact side is covered with this knitted fabric so as to have the straight portions located on the surface side of the inversion portions.

### CITATION LIST

### Patent Literature

PATENT LITERATURE 1: International Publication No. WO2018/142843

### SUMMARY OF THE INVENTION

### Technical Problem

Various means have been proposed to reduce abnormal sound generated during water exposure. However, the current abnormal sound reduction effect is not at a satisfactory level, and further improvement is required.

The present invention has been made in view of such circumstances, and an object of the present invention is to provide a friction transmission belt that can reduce abnormal sound generated during water exposure.

### Solution to Problem

The present inventors have investigated in detail the generation behavior of abnormal sound during water exposure. As a result, the present inventors have found that in the relationship between a slipping speed and a friction coefficient, the decrease rate of the friction coefficient in a zone from a point at which the friction coefficient indicates a maximum friction coefficient to a point at which the slipping speed increases to 500 mm/s is deeply involved in generation of abnormal sound, and thus have completed the present invention.

(1) A friction transmission belt according to the present invention is a friction transmission belt including a belt body which transmits power to a pulley by a frictional force generated when coming into contact with the pulley, wherein in a relationship between a friction coefficient and a slipping speed which is a difference between a speed of the belt body and a speed of the pulley, when a slipping speed at which a maximum friction coefficient is indicated is defined as a first slipping speed, a friction coefficient when the slipping speed is increased from the first slipping speed to a second slipping speed is defined as a reference friction coefficient, and a difference between the second slipping speed and the first slipping speed is 500 mm/s,

a decrease rate Dm of the friction coefficient indicated by the following equation (1) with the maximum friction coefficient being denoted by μx and the reference friction coefficient being denoted by μr is not greater than 20%,

Dm=(μx−μr)/μx×100 (1).

In the friction transmission belt, a decrease in the friction coefficient is suppressed in a zone from the point at which the friction coefficient indicates the maximum friction coefficient to the point at which the slipping speed increases to 500 mm/s. In the friction transmission belt, stick-slip due to water exposure is less likely to occur. Therefore, abnormal sound generated during water exposure is reduced.

(2) In the friction transmission belt, when a zone from the first slipping speed to the second slipping speed is equally divided into n sections (n is a natural number of 2 or more), a slipping speed at start of each section is defined as a start speed, a friction coefficient at the start speed is defined as a start friction coefficient, a slipping speed at end of the section is defined as an end speed, and a friction coefficient at the end speed is defined as an end friction coefficient,

a decrease rate Dsm of the friction coefficient indicated by the following equation (2) with the start friction coefficient and the end friction coefficient in an mth section (m is a natural number of not less than 1 and not greater than n) being denoted by μsm and μem, respectively, is preferably not greater than 20/n % in all the sections,

Dsm=(μsm−μem)/μsm×100 (2).

In this case, in all the sections included in the zone, the friction coefficient is prevented from significantly decreasing. In the zone, the friction coefficient gradually decreases. In the friction transmission belt, occurrence of stick-slip due to water exposure is effectively suppressed. Therefore, abnormal sound is less likely to be generated during water exposure.

(3) In the friction transmission belt, preferably, the belt body includes a compression rubber layer which comes into contact with the pulley, and the compression rubber layer includes a rubber layer body formed from a rubber composition, and a fiber member layer stacked on the rubber layer body. In this case, the fiber member layer absorbs water. Therefore, a water film is less likely to be formed between the belt body and the pulley. In the friction transmission belt, a significant decrease in the friction coefficient is prevented.

(4) In the friction transmission belt, a void ratio of a surface layer portion of the compression rubber layer is preferably not less than 10%. In this case, the voids formed in the surface layer portion contribute to absorption of water. In the friction transmission belt, a water film is less likely to be formed between the belt body and the pulley.

(5) In the friction transmission belt, the void ratio is more preferably not less than 20%. In this case, water is effectively absorbed by the voids formed in the surface layer portion. In the friction transmission belt, a water film is less likely to be formed between the belt body and the pulley.

(6) In the friction transmission belt, preferably, the fiber member layer is formed from a knitted fabric, and the knitted fabric contains a cellulose-based fiber as a main fiber. The cellulose-based fiber has excellent water absorption performance. In the friction transmission belt, a water film is less likely to be formed between the belt body and the pulley.

(7) In the friction transmission belt, a plurality of V-shaped ribs are preferably formed in the compression rubber layer so as to project on an inner peripheral side. The friction transmission belt is a V-ribbed belt. In the friction transmission belt, stick-slip due to water exposure is less likely to occur. Therefore, abnormal sound generated during water exposure is reduced.

### Advantageous Effects of the Invention

In the friction transmission belt according to the present invention, a decrease in the friction coefficient is suppressed in the zone from the point at which the friction coefficient indicates the maximum friction coefficient to the point at which the slipping speed increases to 500 mm/s. In the friction transmission belt, stick-slip due to water exposure is less likely to occur. Therefore, abnormal sound generated during water exposure is reduced.

### BRIEF DESCRIPTION OF DRAWINGS

FIG. 1 is a diagram schematically showing a part of a V-ribbed belt according to an embodiment of the present invention.

FIG. 2 illustrates a layout of pulleys of a belt running tester for evaluating a dynamic friction coefficient during water exposure.

FIG. 3A is a graph showing the measurement results of a friction coefficient.

FIG. 3B is an enlarged view of the graph shown in FIG. 3A.

FIG. 4A is a diagram for illustrating a method for measuring a void ratio.

FIG. 4B is a diagram for illustrating the method for measuring a void ratio.

FIG. 4C is a diagram for illustrating the method for measuring a void ratio.

FIG. 5A is a cross-sectional view of a crosslinking device.

FIG. 5B is an enlarged cross-sectional view of a part of the crosslinking device shown in FIG. 5A.

FIG. 6A is a diagram for illustrating a method for manufacturing the V-ribbed belt shown in FIG. 1.

FIG. 6B is a diagram for illustrating the method for manufacturing the V-ribbed belt shown in FIG. 1.

FIG. 6C is a diagram for illustrating the method for manufacturing the V-ribbed belt shown in FIG. 1

FIG. 7 illustrates a layout of pulleys of a belt running tester for evaluating abnormal sound during water exposure.

### DETAILED DESCRIPTION

Hereinafter, an embodiment of the present invention will be described with reference to the drawings.

### (Friction Transmission Belt)

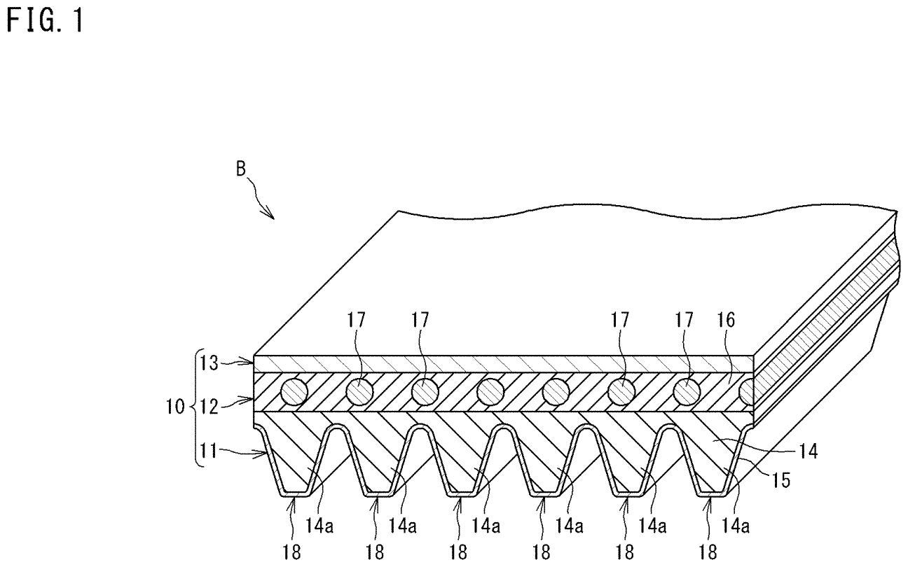

FIG. 1 schematically shows a part of a friction transmission belt B according to an embodiment of the present invention.

The friction transmission belt B is a V-ribbed belt used, for example, for an auxiliary driving belt transmission device provided in an automotive engine compartment, or the like. The V-ribbed belt B has, for example, a belt circumference of not less than 700 mm and not greater than 3000 mm, a belt width of not less than 10 mm and not greater than 36 mm, and a belt thickness of not less than 3.5 mm and not greater than 5.0 mm.

This V-ribbed belt B includes an endless band-shaped belt body 10.

In the V-ribbed belt B, the belt body 10 transmits power to a pulley by a frictional force generated when a surface on the inner peripheral side of the belt body 10 comes into contact with the pulley.

The belt body 10 includes a compression rubber layer 11 which is located on the belt inner peripheral side, an adhesive rubber layer 12 which is located in the middle, and a backface reinforcing fabric 13 which is located on the belt outer peripheral side.

The compression rubber layer 11 extends in the belt longitudinal direction. The compression rubber layer 11 comes into contact with a pulley such as a driving pulley and a driven pulley. The compression rubber layer 11 includes a rubber layer body 14 and a fiber member layer 15.

The rubber layer body 14 is also referred to as a compression rubber layer body. The thickness of the rubber layer body 14 is, for example, not less than 2.0 mm and not greater than 3.2 mm.

The rubber layer body 14 is formed from a rubber composition (hereinafter, referred to as crosslinked rubber composition) containing a crosslinked rubber component. The rubber composition is a crosslinked product obtained by heating and pressurizing an uncrosslinked rubber composition (raw material composition) obtained by blending and kneading various rubber compounding ingredients including a crosslinking agent with a rubber component; and crosslinking the rubber component by the crosslinking agent.

Examples of the rubber component included in the raw material composition include: ethylene-α-olefin elastomers such an ethylene-propylene-diene terpolymer (EPDM), an ethylene-propylene copolymer (EPM), an ethylene-butene copolymer (EDM), and an ethylene-octene copolymer (EOM); chloroprene rubber (CR); chlorosulfonated polyethylene rubber (CSM); and hydrogenated acrylonitrile rubber (H-NBR). As the rubber component, one or more of these rubbers are preferably used, and ethylene-α-olefin elastomers are more preferably used, and EPDM is further preferably used.

Examples of the crosslinking agent included in the raw material composition include sulfur and an organic peroxide.

Examples of rubber compounding ingredients other than the crosslinking agent include a reinforcing material such as carbon black, a filler, an antioxidant, a softener, a vulcanization accelerator, a vulcanization accelerator aid, a co-crosslinking agent, and short fibers.

The fiber member layer 15 is stacked on the surface on the inner peripheral side of the rubber layer body 14. The fiber member layer 15 forms the surface on the inner peripheral side of the belt body 10. The thickness of the fiber member layer 15 is, for example, not less than 0.1 mm and not greater than 1.5 mm.

In the V-ribbed belt B, the fiber member layer 15 covers the entire surface on the inner peripheral side of the rubber layer body 14. The fiber member layer 15 may be stacked on the surface on the inner peripheral side so as to cover a part of the surface on the inner peripheral side.

The fiber member layer 15 may be formed from a woven fabric or a knitted fabric. Examples of the weave structure of the woven fabric include plain weave, twill weave, sateen weave, and derivative weave thereof. Examples of the knitting structure of the knitted fabric include flat stitch, rib stitch, pearl stitch, and other derivative stitch for weft knitting, and single denbigh stitch, single vandyke stitch, and other derivative stitch for warp knitting. The fiber member layer 15 is preferably formed from a knitted fabric from the viewpoint of being highly elastic and capable of uniformly covering the rubber layer body 14.

In the V-ribbed belt B, the fiber member layer 15 may be a crosslinked rubber composition containing a short fiber.

In the case where the fiber member layer 15 is formed from a woven fabric or a knitted fabric, in the V-ribbed belt B, a fiber member layer 15 that is subjected to an adhesion treatment may be used, or a fiber member layer 15 that is not subjected to an adhesion treatment may be used. From the viewpoint of the following (1) and (2), in the V-ribbed belt B, in the case where the fiber member layer 15 is formed from a woven fabric or a knitted fabric, a fiber member layer 15 that is not subjected to an adhesion treatment is preferably used.

(1) In the V-ribbed belt B, since the rubber layer body 14 of the compression rubber layer 11 is formed from a crosslinked rubber composition, even if the fiber member layer 15 is not subjected to an adhesion treatment, the rubber layer body 14 and the fiber member layer 15 are adhered to each other with sufficient adhesive strength.

(2) In addition, in a V-ribbed belt B including a fiber member layer 15 that is not subjected to an adhesion treatment, generation of abnormal sound during water exposure is suppressed as compared to that in a V-ribbed belt B including a fiber member layer 15 that is subjected to an adhesion treatment. It is inferred that this is because the fiber member layer 15 that is not subjected to an adhesion treatment tends to have better water absorption characteristics than the fiber member layer 15 that is subjected to an adhesion treatment.

In the friction transmission belt B, the fiber member layer 15 not being subjected to an adhesion treatment means that an adhesion treatment of immersing the fiber member layer 15 in an adhesive is not performed and the adhesive is not adhered to the surface of the fiber member layer 15.

Examples of the “adhesion treatment of immersion in an adhesive” include a treatment of immersion in an epoxy resin solution or an isocyanate resin solution and heating, a treatment of immersion in an RFL aqueous solution and heating, and a treatment of immersion in rubber cement and drying.

In the case where the fiber member layer 15 is formed from a woven fabric, a warp and a weft are used for forming the fiber member layer 15. In the case where the fiber member layer 15 is formed from a knitted fabric, a knitting yarn is used for forming the fiber member layer 15.

Examples of the fibers forming the yarn used for forming the fiber member layer 15 include: natural fibers such as cellulose-based fibers, wool, and silk; and synthetic fibers such as polyurethane fibers, aliphatic polyamide fibers (nylon 66 fibers), aromatic polyamide fibers (para-type, meta-type), polyester fibers, acrylic fibers, and polyvinyl alcohol fibers. The fiber member layer 15 may be formed from one of these fibers, or may be formed from two or more of these fibers.

As the fibers forming the fiber member layer 15, cellulose-based fibers are preferable from the viewpoint of having good water absorption performance.

In the V-ribbed belt B, the fiber member layer 15 preferably contains a cellulose-based fiber as a main fiber, since the cellulose-based fiber is suitable for the fiber member layer 15 to ensure good water absorption characteristics. As described above, the fiber member layer 15 is preferably formed from a knitted fabric from the viewpoint of being highly elastic and capable of uniformly covering the rubber layer body 14. Therefore, in the V-ribbed belt B, more preferably, the fiber member layer 15 is formed from a knitted fabric, and the knitted fabric contains a cellulose-based fiber as a main fiber.

In the case where the fiber member layer 15 contains a cellulose-based fiber as a main fiber, the proportion of the cellulose-based fiber to the fibers forming the fiber member layer 15 is preferably not less than 50% by mass and more preferably not less than 70% by mass. The proportion of the cellulose-based fiber may be 100% by mass. In the case where the fiber member layer 15 contains a cellulose-based fiber as a main fiber, from the viewpoint of ensuring good water absorption characteristics, the cellulose-based fiber is preferably exposed on the surface of the fiber member layer 15 (the inner peripheral surface of the belt body 10).

In the case where the fiber member layer 15 contains a cellulose-based fiber as a main fiber, the fiber member layer 15 can contain another fiber other than the cellulose-based fiber. In this case, as the other fiber, polyurethane fibers and aliphatic polyamide fibers are preferable. From the viewpoint of ensuring elasticity, polyurethane fibers are more preferable as the other fiber.

Examples of the cellulose-based fiber include cellulose fibers derived from natural plants such as wood pulp of needle-leaved trees and broad-leaved trees, bamboo fibers, sugar cane fibers, cotton fibers, and kapok seed hair fibers, bast fibers of hemp, kozo (paper mulberry), and mitsumata (oriental paperbush), and leaf fibers of Manila hemp and New Zealand hemp; cellulose fibers derived from animals such as sea squirt cellulose; bacterial cellulose fibers; algae cellulose fibers; cellulose ester fibers; and regenerated cellulose fibers such as rayon, cupra, and lyocell.

Among these, cotton fibers are preferable from the viewpoint of practicality as a fiber material.

The adhesive rubber layer 12 is a band having a horizontally long rectangular cross-sectional shape and extending in the belt longitudinal direction. The thickness of the adhesive rubber layer 12 is, for example, not less than 1.0 mm and not greater than 2.5 mm. The adhesive rubber layer 12 includes an adhesive rubber layer body 16 and a core wire 17 covered with the adhesive rubber layer body 16.

The adhesive rubber layer body 16 is formed from a crosslinked rubber composition. As described above, the compression rubber layer body 14 is also formed from a crosslinked rubber composition. In the V-ribbed belt B, the compression rubber layer body 14 and the adhesive rubber layer body 16 may be formed from the same rubber composition, or may be formed from different rubber compositions.

The core wire 17 is located in a middle portion in the belt thickness direction of the adhesive rubber layer 12. The core wire 17 is wound to form a helical pattern having a pitch in the belt width direction, and embedded in the adhesive rubber layer body 16.

The core wire 17 is formed from a twisted yarn made of a polyamide fiber, a polyester fiber, an aramid fiber, a polyamide fiber, or the like. The diameter of the core wire 17 is, for example, not less than 0.5 mm and not greater than 2.5 mm, and the shortest distance between the core wires 17 adjacent to each other in a cross-section of the adhesive rubber layer 12 is, for example, not less than 0.05 mm and not greater than 0.20 mm.

Preferably, the core wire 17 is subjected to one or more of an adhesion treatment of immersing the core wire 16 in an epoxy resin solution or an isocyanate resin solution and heating the core wire 16, an adhesion treatment of immersing the core wire 16 in an RFL aqueous solution and then heating the core wire 16, and an adhesion treatment of immersing the core wire 16 in rubber cement and then drying the core wire 16.

The backface reinforcing fabric 13 is formed from, for example, a fabric material, a knitted fabric, a non-woven fabric, or the like, using yarns made of cotton, polyamide fibers, polyester fibers, aramid fibers, or the like. The fabric material is, for example, plain-woven, twilled, or sateen-woven. The thickness of the backface reinforcing fabric 13 is, for example, not less than 0.4 mm and not greater than 1.2 mm.

In order to provide adhesiveness with respect to the adhesive rubber layer 12, an adhesion treatment of immersing the backface reinforcing fabric 13 in an RFL aqueous solution and heating the backface reinforcing fabric 13 before molding processing, and/or an adhesion treatment of coating the outer peripheral surface of the adhesive rubber layer 12 with rubber cement and drying the surface, may be performed for the backface reinforcing fabric 13. The backface reinforcing fabric 13 may be attached to the adhesive rubber layer 12 via a rubber layer (not shown).

In the V-ribbed belt B, a backface rubber layer having a thickness of, for example, not less than 0.4 mm and not greater than 0.8 mm may be used instead of the backface reinforcing fabric 13. In this case, from the viewpoint of suppressing generation of sound during back-surface driving, the grain of a woven fabric is preferably transferred to the surface of the backface rubber layer. From the viewpoint of suppressing occurrence of adhesion due to contact between the belt backface and a flat pulley, the backface rubber layer is preferably formed from a rubber composition slightly harder than that of the adhesive rubber layer body 16.

In the case where a backface rubber layer is provided, the backface rubber layer may be formed from the same rubber composition as that of either one of or both the compression rubber layer body 14 and the adhesive rubber layer body 16, or may be formed from a rubber composition different from those of the compression rubber layer body 14 and the adhesive rubber layer body 16.

In the case where the backface rubber layer is formed from a rubber composition different from that of the adhesive rubber layer body 16, from the viewpoint of suppressing occurrence of adhesion due to contact between the belt backface and a flat pulley, the backface rubber layer is preferably formed from a rubber composition slightly harder than that of the adhesive rubber layer body 16.

As shown in FIG. 1, in the V-ribbed belt B, a plurality of V-shaped ribs 18 are formed in the compression rubber layer 11 of the belt body 10 so as to protrude on the inner peripheral side. The plurality of V-shaped ribs 18 are each a ridge having a substantially inverted triangular cross section and extending in the belt longitudinal direction. The plurality of V-shaped ribs 18 are aligned in the belt width direction.

Each V-shaped rib 18 has, for example, a rib height of not less than 2.0 mm and not greater than 3.0 mm, and the width between the base ends thereof is, for example, not less than 1.0 mm and not greater than 3.6 mm. The number of V-shaped ribs 18 is, for example, not less than three and not greater than ten (six in FIG. 1).

In the V-ribbed belt B, a plurality of V-shaped rib bodies 14a are formed in the rubber layer body 14 of the compression rubber layer 11 so as to project on the inner peripheral side. The V-shaped ribs 18 are formed by covering the plurality of V-shaped rib bodies 14a with the fiber member layer 15. In the V-ribbed belt B, the surface of each V-shaped rib 18 covered with the fiber member layer 15 serves as a pulley contact surface.

The present inventors have investigated in detail the generation behavior of abnormal sound in the friction transmission belt B during water exposure. As a result, the present inventors have found that in the relationship between a slipping speed and a friction coefficient, the decrease rate of the friction coefficient in a zone from a point at which the friction coefficient indicates a maximum friction coefficient to a point at which the slipping speed increases to 500 mm/s is deeply involved in generation of abnormal sound, and thus have completed the present invention.

Hereinafter, the relationship between a slipping speed and a friction coefficient in the friction transmission belt B shown in FIG. 1 will be described, but prior to this description, a belt running tester used for obtaining this relationship and an evaluation method for obtaining this relationship will be described.

### (Belt Running Tester)

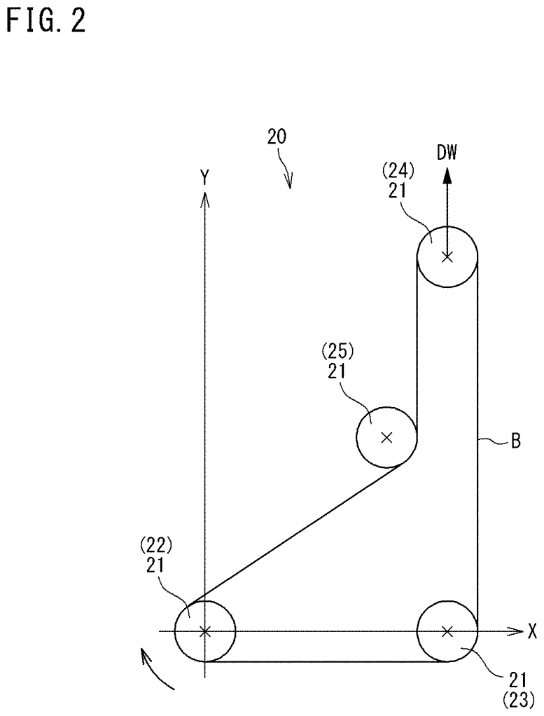

FIG. 2 illustrates an example of a layout of pulleys of a belt running tester 20 for evaluating a dynamic friction coefficient during water exposure. The belt running tester 20 (hereinafter, referred to as tester) is configured to be able to evaluate the dynamic friction coefficient during water exposure of a V-ribbed belt B (belt length=1080 mm) having six V-shaped ribs 18 formed therein, as the friction transmission belt B. With the tester 20, it is possible to evaluate another friction transmission belt B such as a V-belt or a flat belt by changing the specifications of the pulleys.

The tester 20 includes four pulleys 21. The four pulleys 21 are:

(1) a first driving pulley 22 which is a rib pulley;

(2) a second driving pulley 23 which is located on the right side of the first driving pulley 22 and is a rib pulley;

(3) a driven pulley 24 which is located above the second driving pulley 23 and is a rib pulley; and

(4) an idler pulley 25 which is located on the lower left side of the driven pulley 24 and is a flat pulley.

The pulley diameter of each pulley 21 is 50 mm. Each pulley 21 is made of SUS. The surface roughness (arithmetic average roughness Ra) of the contact surface, of each pulley 21, which comes into contact with the V-ribbed belt B is 3.2 μm.

In the tester 20, the rib side of the V-ribbed belt B comes into contact with the first driving pulley 22, the second driving pulley 23, and the driven pulley 24. The backface side of the V-ribbed belt B comes into contact with the idler pulley 25.

A motor and a torque meter are connected to each of the first driving pulley 22 and the second driving pulley 23. In the tester 20, it is possible to control the rotation speeds of the first driving pulley 22 and the second driving pulley 23 and measure torques generated in the first driving pulley 22 and the second driving pulley 23.

A weight is connected to the driven pulley 24 such that a constant tension is applied to the V-ribbed belt B. In the tester 20, a dead weight DW is set such that a tension of 10 kgf (98 N) is generated per V-shaped rib 18.

Table 1 below shows accurate placement of each pulley 21. In Table 1, the center coordinates of each pulley 21 are shown with the center of the first driving pulley 22 as the origin (0, 0) of XY coordinates in FIG. 2. For example, the center coordinates (200, 308.91) of the driven pulley 24 indicate a position located 200 mm to the right and 308.91 mm above with respect to the center of the first driving pulley 22 which is the origin.

TABLE 1

| | | Pulley | | |
|---|---|---|---|---|
| Reference | | diameter | Coordinates | |
| sign | Pulley | [mm] | X [mm] | Y [mm] |
| 22 | First driving pulley | 50 | 0 | 0 |
| 23 | Second driving pulley | 50 | 200 | 0 |
| 24 | Driven pulley | 50 | 200 | 308.91 |
| 25 | Idler pulley | 50 | 150 | 160 |

In the tester 20, when each pulley 21 is placed as shown in Table 1, the contact angle of the friction transmission belt B (V-ribbed belt B) with the second driving pulley 23 is set to 90 degrees.

### (Evaluation Method)

The relationship between a slipping speed and a friction coefficient in the V-ribbed belt B as the friction transmission belt B is obtained as follows. This evaluation method is carried out at an atmosphere temperature of 18° C. to 28° C.

(1) The V-ribbed belt B shown in FIG. 1 is trained around each pulley 21.
(2) The weight is connected to the driven pulley 24. Since the V-ribbed belt B has six V-shaped ribs 18, the tension of the V-ribbed belt B is set to 588 N (60 kgf).
(3) The motors are driven to rotate the first driving pulley 22 and the second driving pulley 23.
(4) Water is dropped on the rib side of the V-ribbed belt B in a volume of 40 ml per minute at an approach portion of the V-ribbed belt B to the first driving pulley 22.
(5) The rotation speeds of the first driving pulley 22 and the second driving pulley 23 are each set to 1000 rpm, and the V-ribbed belt B is caused to run at a constant speed.
(6) After 30 minutes from the start of running at a constant speed, the rotational speed of the second driving pulley 23 is decreased to 500 rpm in 30 seconds at a constant deceleration, and the torque of the second driving pulley 23 is measured in the deceleration process.
(7) From the measured torque, tight side tension T1 (N) represented as the tension between the first driving pulley 22 and the second driving pulley 23 and slack side tension T2 (N) represented as the tension between the second driving pulley 23 and the driven pulley 24 are obtained, and a dynamic friction coefficient (hereinafter, referred to as friction coefficient) is calculated by using Euler's equation. Accordingly, the relationship between the friction coefficient and a slipping speed that is the difference between the speed of the belt body 10 and the speed of the second driving pulley 23 is obtained.

### (Relationship Between Slipping Speed and Friction Coefficient)

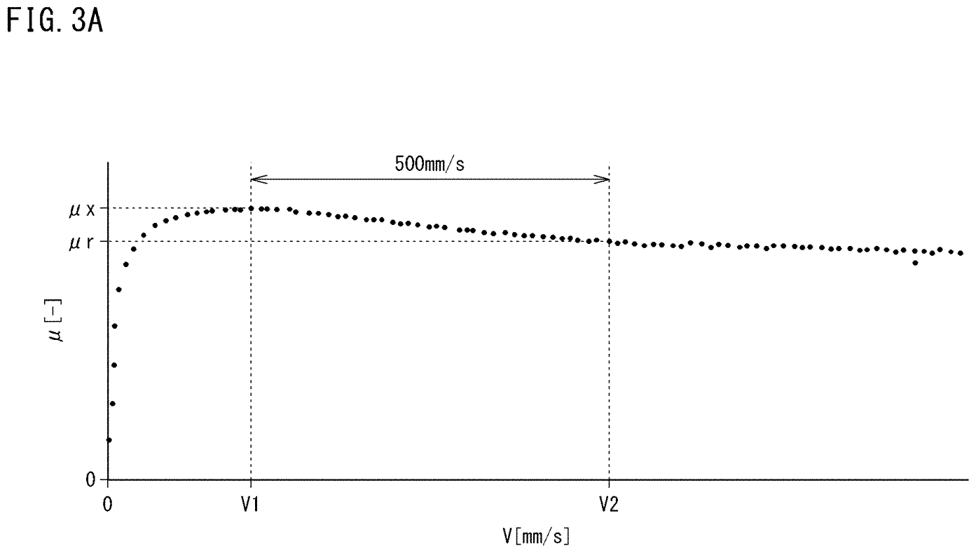

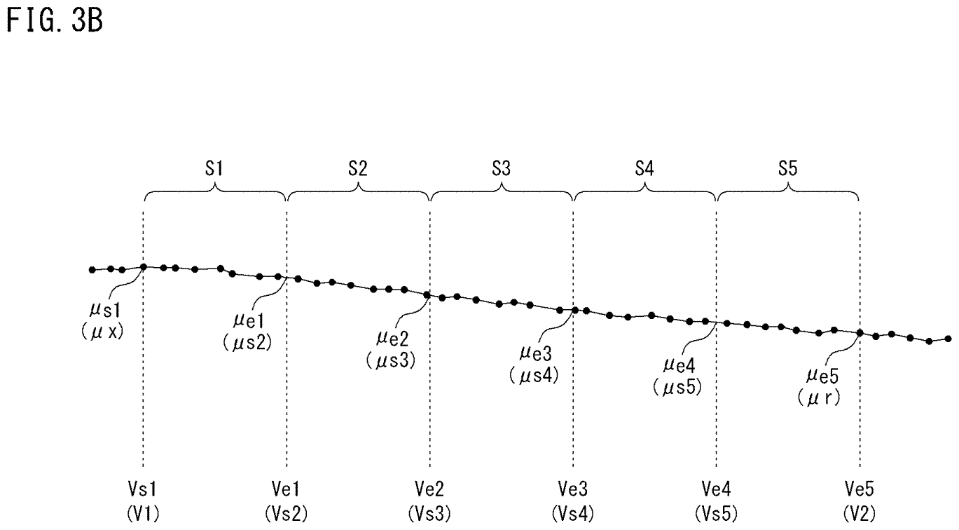

FIG. 3A shows an example of the measurement results, of the friction coefficient of the friction transmission belt B (V-ribbed belt B) shown in FIG. 1, obtained by using a belt running tester 20 shown in FIG. 2. FIG. 3A shows the relationship between the slipping speed and the friction coefficient. In FIG. 3A, a horizontal axis V indicates the slipping speed (mm/s). A slipping speed V at the start of deceleration of the second driving pulley 23 is 0 mm/s. A vertical axis μ indicates the friction coefficient.

As shown in FIG. 3A, as the second driving pulley 23 starts decelerating and the slipping speed V increases, the friction coefficient μ sharply increases in the friction transmission belt B. Then, the increase rate of the friction coefficient μ gradually decreases. After the friction coefficient μ indicates a maximum friction coefficient, the friction coefficient μ gradually decreases as the slipping speed V increases. In FIG. 3A, reference sign μx denotes the maximum friction coefficient, and reference sign V1 denotes the slipping speed at which the maximum friction coefficient μx is indicated, that is, a first slipping speed. Reference sign V2 denotes a second slipping speed, and reference sign μr denotes the friction coefficient when the slipping speed V is increased from the first slipping speed V1 to the second slipping speed V2, that is, a reference friction coefficient. As shown in FIG. 3A, the reference friction coefficient μr is lower than the maximum friction coefficient μx.

In the friction transmission belt B, in the relationship between the slipping speed V and the friction coefficient μ, a decrease rate Dm of the friction coefficient μ is indicated by the following equation (1) with the maximum friction coefficient being denoted by μx and the reference friction coefficient being denoted by μr.

Dm=(μx−μr)/μx×100 (1)

In the friction transmission belt B, when the difference (V2−V1) between the second slipping speed V2 and the first slipping speed V1 is 500 mm/s, the decrease rate Dm of the friction coefficient μ indicated by equation (1) is not greater than 20%.

In the friction transmission belt B, a decrease in the friction coefficient μ is suppressed in a zone from the point at which the friction coefficient μ indicates the maximum friction coefficient μx to the point at which the slipping speed V increases to 500 mm/s. In the friction transmission belt B, stick-slip due to water exposure is less likely to occur. Therefore, abnormal sound generated during water exposure is reduced.

FIG. 3B is an enlarged view of the graph shown in FIG. 3A. FIG. 3B shows the relationship between the slipping speed V and the friction coefficient μ in a zone from the first slipping speed V1 to the second slipping speed V2 (hereinafter, referred to as evaluation target zone).

As shown in FIG. 3B, in the friction transmission belt B, the change of the friction coefficient μ is suppressed to be small in the evaluation target zone. Therefore, in the friction transmission belt B, stick-slip due to water exposure is less likely to occur, so that abnormal sound is less likely to be generated during water exposure. However, it is undeniable that even when the decrease rate Dm of the friction coefficient μ indicated by the above-described equation (1) is not greater than 20%, a section in which the friction coefficient μ greatly decreases may exist in the evaluation target zone. In such a case, there is a concern that stick-slip due to water exposure may occur and abnormal sound may be generated.

Therefore, when the evaluation target zone is equally divided into n sections (n is a natural number of 2 or more), the slipping speed at the start of each section is defined as a start speed, the friction coefficient μ at the start speed is defined as a start friction coefficient, the slipping speed at the end of this section is defined as an end speed, and the friction coefficient μ at the end speed is defined as an end friction coefficient, a decrease rate Dsm of the friction coefficient μ indicated by the following equation (2) with a start friction coefficient and an end friction coefficient in an mth section Sm (m is a natural number of not less than 1 and not greater than n) being denoted by μsm and μem, respectively, is preferably not greater than 20/n % in all the sections.

Dsm=(μm−μem)/μsm×100 (2)

FIG. 3B shows the case where the evaluation target zone is equally divided into five sections. Hereinafter, the decrease rate Dsm of the friction coefficient μ indicated by the above-described equation (2) being not greater than 20/n % in all the sections will be described with this case as an example.

In FIG. 3B, regions indicated by reference signs S1 to S5 represent the respective sections obtained by equally dividing the evaluation target zone into five parts. The section having the first slipping speed V1 as a start speed is a first section S1, and the section having the second slipping speed V2 as an end speed is a fifth section S5.

Since the width of the evaluation target zone is 500 mm/s, when the evaluation target zone is equally divided into five parts, the width of each section Sm is 100 mm/s.

Reference sign Vs1 denotes the start speed of the first section S1. Reference sign μs1 denotes the friction coefficient at the start speed Vs1, and the friction coefficient μs1 is the start friction coefficient of the first section S1. Since the first section S1 is a section having the first slipping speed V1 as the start speed Vs1, the start friction coefficient μs1 is also the maximum friction coefficient μx. Reference sign Ve1 denotes the end speed of the first section S1. Reference sign μe1 denotes the friction coefficient at the end speed Ve1, and the friction coefficient μe1 is the end friction coefficient of the first section S1. Therefore, a decrease rate Ds1 of the friction coefficient μ in the first section S1 is indicated by the following equation (2a).

Ds1=(μs1−μe1)/μs1×100 (2a)

Reference sign Vs2 denotes the start speed of the second section S2. Reference sign μs2 denotes the friction coefficient at the start speed Vs2, and the friction coefficient μs2 is the start friction coefficient of the second section S2. Since the start speed Vs2 is the above-described end speed Ve1, the start friction coefficient μs2 is also the above-described end friction coefficient μe1. Reference sign Ve2 denotes the end speed of the second section S2. Reference sign μe2 denotes the friction coefficient at the end speed Ve2, and the friction coefficient μe2 is the end friction coefficient of the second section S2. Therefore, a decrease rate Ds2 of the friction coefficient μ in the second section S2 is indicated by the following equation (2b).

Ds2=(μs2−μe2)/μs2×100 (2b)

Reference sign Vs3 denotes the start speed of the third section S3. Reference sign μs3 denotes the friction coefficient at the start speed Vs3, and the friction coefficient μs3 is the start friction coefficient of the third section S3. Since the start speed Vs3 is the above-described end speed Ve2, the start friction coefficient μs3 is also the above-described end friction coefficient μe2. Reference sign Ve3 denotes the end speed of the third section S3. Reference sign μe3 denotes the friction coefficient at the end speed Ve3, and the friction coefficient μe3 is the end friction coefficient of the third section S3. Therefore, a decrease rate Ds3 of the friction coefficient μ in the third section S3 is indicted by the following equation (2c).

Ds3=(μs3−μe3)/μs3×100 (2c)

Reference sign Vs4 denotes the start speed of the fourth section S4. Reference sign μs4 denotes the friction coefficient at the start speed Vs4, and the friction coefficient μs4 is the start friction coefficient of the fourth section S4. Since the start speed Vs4 is the above-described end speed Ve3, the start friction coefficient μs4 is also the above-described end friction coefficient μe3. Reference sign Ve4 denotes the end speed of the fourth section S4. Reference sign μe4 denotes the friction coefficient at the end speed Ve4, and the friction coefficient μe4 is the end friction coefficient of the fourth section S4. Therefore, a decrease rate Ds4 of the friction coefficient μ in the fourth section S4 is indicated by the following equation (2d).

Ds4=(μs4−μe4)/μs4×100 (2d)

Reference sign Vs5 denotes the start speed of the fifth section S5. Reference sign μs5 denotes the friction coefficient at the start speed Vs5, and the friction coefficient μs5 is the start friction coefficient of the fifth section S5. Since the start speed Vs5 is the above-described end speed Ve4, the start friction coefficient μs5 is also the above-described end friction coefficient μe4. Reference sign Ve5 denotes the end speed of the fifth section S5. Reference sign μe5 denotes the friction coefficient at the end speed Ve5, and the friction coefficient μe5 is the end friction coefficient of the fifth section S5. Since the fifth section S5 is a section having the second slipping speed V2 as the end speed Vs5, the end friction coefficient μe5 is also the reference friction coefficient μr. Therefore, a decrease rate Ds5 of the friction coefficient μ in the fifth section S5 is indicated by the following equation (2e).

Ds5=(μs5−μe5)/μs5×100 (2e)

In the friction transmission belt B, preferably, the decrease rate Ds1 of the friction coefficient μ in the first section S1, the decrease rate Ds2 of the friction coefficient μ in the second section S2, the decrease rate Ds3 of the friction coefficient μ in the third section S3, the decrease rate Ds4 of the friction coefficient μ in the fourth section S4, and the decrease rate Ds5 of the friction coefficient μ in the fifth section S5 are not greater than 4%. In other words, preferably, the decrease rate Dsm of the friction coefficient μ indicated by the above-described equation (2) is not greater than 20/5%, that is, 4%, in all the sections included in the evaluation target zone. Accordingly, in all the sections included in the evaluation target zone, the friction coefficient μ is prevented from significantly decreasing. In the entire evaluation target zone, the friction coefficient μ gradually decreases. In the friction transmission belt B, the variation of the friction coefficient μ is suppressed to be small, so that occurrence of stick-slip due to water exposure is effectively suppressed. Therefore, abnormal sound is less likely to be generated during water exposure.

In the friction transmission belt B, from the viewpoint of effectively suppressing generation of abnormal sound during water exposure, the number n of sections included in the evaluation target zone is preferably not less than 3, more preferably not less than 4, and further preferably not less than 5. It is more preferable if the number n is larger, but if the number n is excessively large, noise due to the measurement accuracy of the slipping speed V and the friction coefficient μ increases. From the viewpoint of being able to accurately determine the effect of suppressing generation of abnormal sound during water exposure, the number n is preferably not greater than 15, more preferably not greater than 12, and further preferably not greater than 10.

In the friction transmission belt B, from the viewpoint of effectively suppressing generation of abnormal sound during water exposure and improving the power transmission efficiency, the upper limit of the decrease rate Dm of the friction coefficient μ indicated by the above-described equation (1) may be set to 15%. In this case, the decrease rate Dsm of the friction coefficient μ indicated by the above-described equation (2) is more preferably not greater than 15/n % in all the sections. From the viewpoint of more effectively suppressing generation of abnormal sound during water exposure and further improving the power transmission efficiency, the upper limit of the decrease rate Dm of the friction coefficient μ indicated by the above-described equation (1) may be set to 10%. In this case, the decrease rate Dsm of the friction coefficient μ indicated by the above-described equation (2) is more preferably not greater than 10/n % in all the sections.

As described above, in the friction transmission belt B, the compression rubber layer 11 includes the rubber layer body 14 and the fiber member layer 15. The fiber member layer 15 forms the surface on the inner peripheral side of the belt body 10 which comes into contact with the pulleys 21. In the friction transmission belt B, the fiber member layer 15 absorbs water. Therefore, a water film is less likely to be formed between the belt body 10 and each pulley 21. In the friction transmission belt B, a significant decrease in the friction coefficient μ is prevented. In the friction transmission belt B, the variation of the friction coefficient μ is suppressed to be small, so that occurrence of stick-slip due to water exposure is effectively suppressed. Therefore, abnormal sound is less likely to be generated during water exposure. From this viewpoint, preferably, the belt body 10 includes the compression rubber layer 11 which comes into contact with the pulleys 21, and the compression rubber layer 11 includes the rubber layer body 14 and the fiber member layer 15 stacked on the rubber layer body 14.

In the friction transmission belt B, the surface of the compression rubber layer 11 comes into contact with the pulleys 21. In the case where the surface of the compression rubber layer 11 is formed by the fiber member layer 15 as in the V-ribbed belt B shown in FIG. 1, voids are formed in a surface layer portion of the compression rubber layer 11 due to the presence of the fiber member layer 15. The voids contribute to absorption of water.

In the friction transmission belt B, when a portion from the surface of the compression rubber layer 11 to 200 μm in the depth direction is defined as the surface layer portion, the void ratio of the surface layer portion is preferably not less than 10%. Accordingly, the voids formed in the surface layer portion contribute to absorption of water. In the friction transmission belt B, a water film is less likely to be formed between the belt body 10 and each pulley 21. In the friction transmission belt B, a significant decrease in the friction coefficient μ is prevented. The variation of the friction coefficient μ is suppressed to be small, so that occurrence of stick-slip due to water exposure is effectively suppressed. Therefore, abnormal sound is less likely to be generated during water exposure. From this viewpoint, the void ratio is more preferably not less than 20%. From the viewpoint of ensuring the rigidity of the surface layer portion, the void ratio is preferably not greater than 70%.

The void ratio of the surface layer portion of the compression rubber layer 11 can be calculated, for example, by using a cross-sectional image of the friction transmission belt B taken by a computed tomography apparatus (“TOSCANER-30902 μhd”, manufactured by TOSHIBA CORPORATION). In the calculation of the void ratio, a three-dimensional image of the surface layer portion is obtained, for example, by trimming the taken cross-sectional image of the friction transmission belt B.

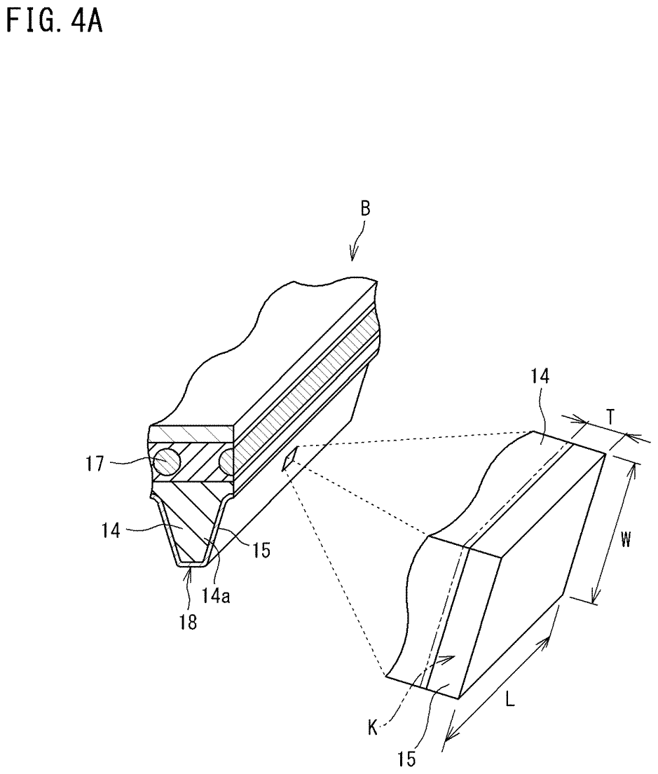

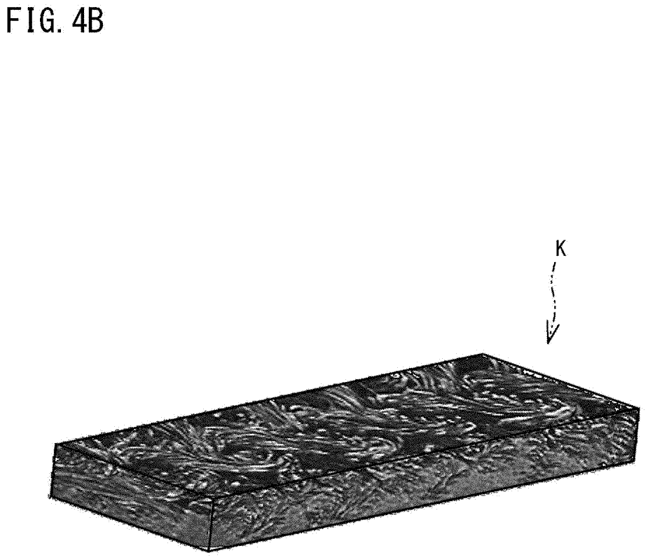

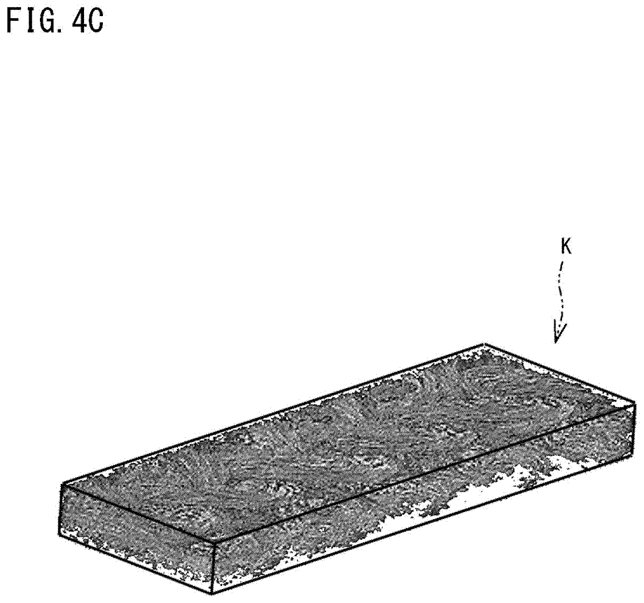

FIG. 4A schematically shows an image of a three-dimensional image of a surface layer portion K obtained by trimming. In FIG. 4A, a length indicated by reference sign T is the thickness of the surface layer portion K used for calculating a void ratio. The thickness T corresponds to the depth from the surface of the compression rubber layer 11 and is set to 200 μm. A length indicated by reference sign W is the width of the surface layer portion K. The width W is set to 800 μm. A length indicated by reference sign L is the length of the surface layer portion K. The length L is set to 2000 μm. The volume of the surface layer portion K obtained by trimming is represented by the product of the thickness T, the width W, and the length L.

When the three-dimensional image of the surface layer portion K is obtained, the three-dimensional image is divided into an image of an object portion made of rubber and fiber and an image of a void portion other than the object portion by using the binarization method of Stack Histogram. The volume of the void portion in the surface layer portion K is calculated on the basis of the image of the void portion grasped by this, and the void ratio of the surface layer portion K of the compression rubber layer 11 which is represented by the ratio of the volume of the void portion to the volume of the surface layer portion K is calculated. FIG. 4B shows an image of the object portion obtained by the binarization process of the three-dimensional image. FIG. 4C shows an image of the void portion obtained by removing the image of the object portion from the three-dimensional image.

Next, a method for manufacturing the V-ribbed belt B described above will be described with reference to the drawings.

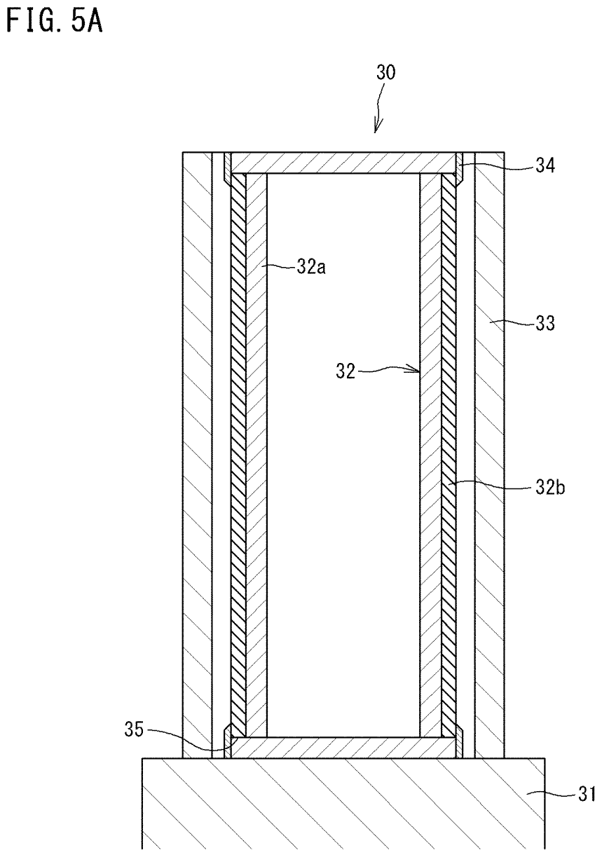

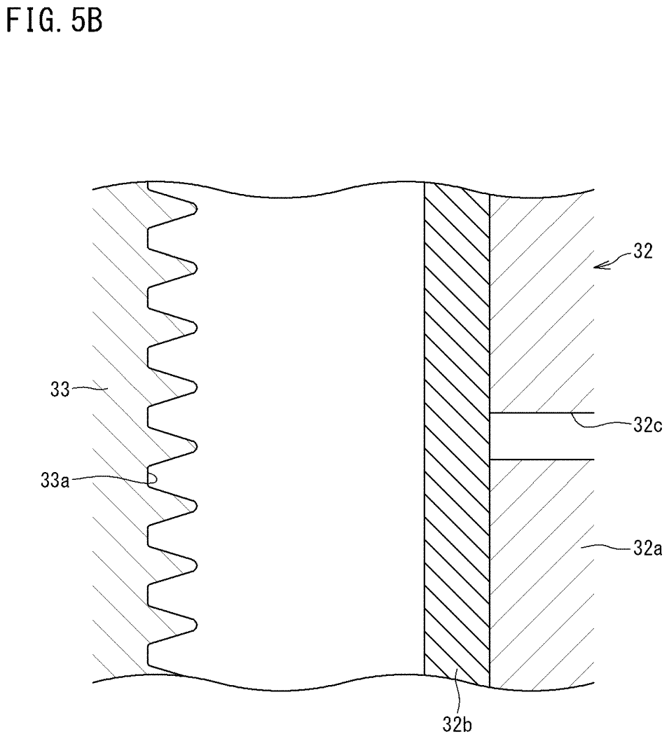

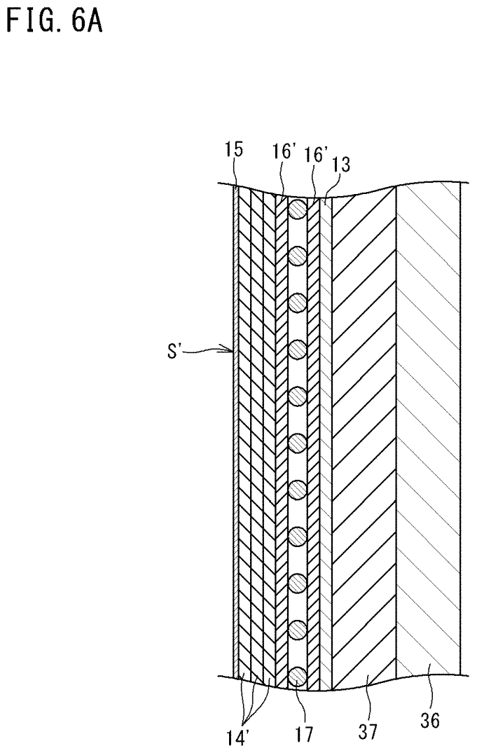

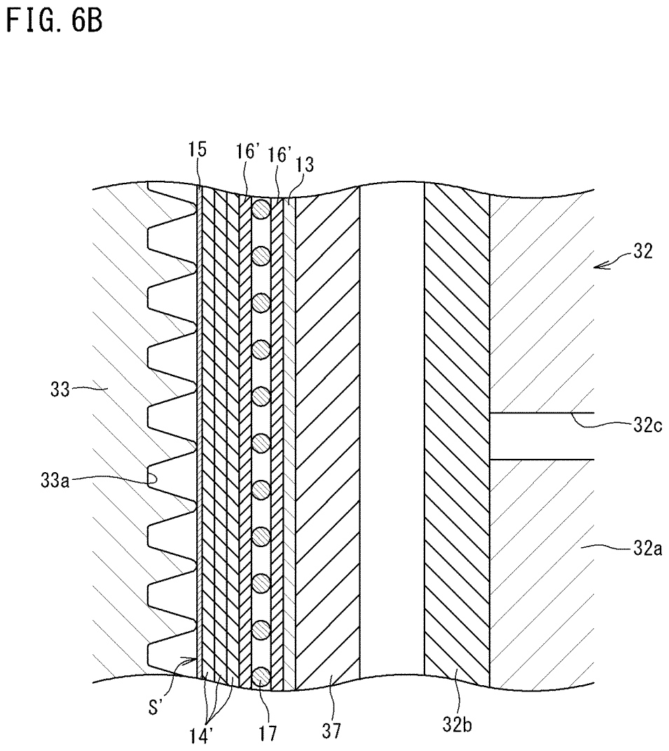

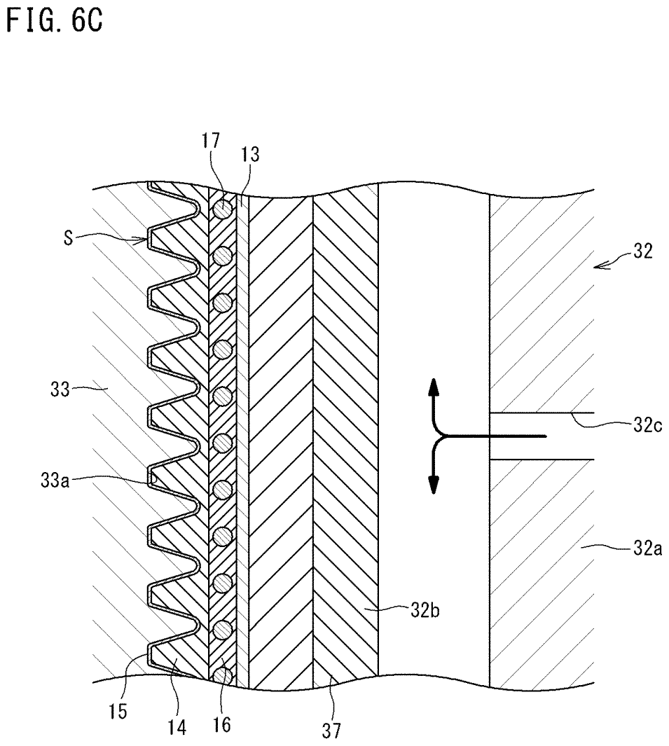

FIG. 5A and FIG. 5B illustrate a crosslinking device 30 used for manufacturing the V-ribbed belt B according to the present embodiment. FIG. 6A, FIG. 6B, and FIG. 6C are each a diagram for illustrating the method for manufacturing the V-ribbed belt B according to the present embodiment.

The crosslinking device 30 includes a base 31, a columnar expansion drum 32 erected on the base 31, and a cylindrical mold 33 provided outside the expansion drum 32.

The expansion drum 32 has a drum body 32a formed in a hollow columnar shape, and a cylindrical expansion sleeve 32b made of rubber and fitted on the outer periphery of the drum body 32a. A large number of ventilation holes 32c are formed on an outer peripheral portion of the drum main body 32a so as to communicate with the interior of the drum body 32a. Both end portions of the expansion sleeve 32b are sealed by fixing rings 34 and 35 between the drum body 32a and the expansion sleeve 32b, respectively. The crosslinking device 30 is provided with pressurizing means (not shown) for introducing high-pressure air into the drum main body 32a to pressurize the interior of the drum main body 32a. The crosslinking device 30 is configured such that when the high-pressure air is introduced into the drum body 32a by the pressurizing means, the high-pressure air passes through the ventilation holes 32c and enters between the drum body 32a and the expansion sleeve 32b to expand the expansion sleeve 32b radially outward.

The cylindrical mold 33 is configured to be attachable to and removable from the base 31. The cylindrical mold 33 attached to the base 31 is provided concentrically with the expansion drum 32 at an interval from the expansion drum 32. The cylindrical mold 33 is provided with a plurality of V-shaped rib forming grooves 33a formed on the inner peripheral surface thereof so as to extend in the circumferential direction and be aligned in the axial direction (groove width direction). Each V-shaped rib forming groove 33a is formed so as to be narrower toward the groove bottom side. Specifically, each V-shaped rib forming groove 33a is formed such that a cross-sectional shape thereof is the same as that of the V-shaped rib 18 of the V-ribbed belt B to be manufactured. The crosslinking device 30 is provided with heating means and cooling means (both not shown) for the cylindrical mold 33. The crosslinking device 30 is configured such that it is possible to control the temperature of the cylindrical mold 33 by the heating means and the cooling means.

In the method for manufacturing the V-ribbed belt B according to the embodiment, first, the rubber compounding ingredients including the crosslinking agent are blended with the rubber component and kneaded with a kneading machine such as a kneader or a Banbury mixer, and the obtained uncrosslinked rubber composition is formed into a sheet shape by calendar molding or the like to produce an uncrosslinked rubber sheet 14′ for the rubber layer body 14 of the compression rubber layer 11. Similarly, an uncrosslinked rubber sheet 16′ for the adhesive rubber layer body 16 of the adhesive rubber layer 12 is also produced. In addition, the fiber member layer 15 formed from a woven fabric or a knitted fabric and the backface reinforcing fabric 13 formed from a woven fabric or a knitted fabric are prepared, and an adhesion treatment is performed thereon as necessary. In the manufacturing method, the fiber member layer 15 is formed in a tubular shape in advance. The backface reinforcing fabric 13 may also be formed in a tubular shape in advance. Furthermore, the core wire 17 is prepared, and an adhesion treatment is performed on the core wire 17 as necessary.

Then, as shown in FIG. 6A, a rubber sleeve 37 is placed on a cylindrical drum 36 having a smooth surface, and the backface reinforcing fabric 13 and the uncrosslinked rubber sheet 16′ for the adhesive rubber layer body 16 are wrapped in this order and stacked over the rubber sleeve 37. The core wire 17 is helically wound over the uncrosslinked rubber sheet 16′, and the uncrosslinked rubber sheet 16′ for the adhesive rubber layer body 16 and the uncrosslinked rubber sheet 14′ for the compression rubber layer body 14 are further wrapped in this order over the core wire 17. Finally, the tubular fiber member layer 15 is placed over the uncrosslinked rubber sheet 14′ to form an uncrosslinked slab S′.

Then, the rubber sleeve 37 on which the uncrosslinked slab S′ has been provided is removed from the cylindrical drum 36. As shown in FIG. 6B, the rubber sleeve 37 is fitted into the inner peripheral surface side of the cylindrical mold 33, and then the cylindrical mold 33 on which the uncrosslinked slab S′ has been provided is attached to the base 31 so as to cover the expansion drum 32.

Subsequently, while heating the cylindrical mold 33, as shown in FIG. 6C, high-pressure air is injected between the drum body 32a and the expansion sleeve 32b of the expansion drum 32 through the ventilation holes 32c to expand the expansion sleeve 32b. At this time, the uncrosslinked slab S′ is pressed against the cylindrical mold 33, the uncrosslinked rubber sheets 14′ and 16′ enter the V-shaped rib forming grooves 33a while pressing and stretching the fiber member layer 15, and crosslinking of the rubber components of the uncrosslinked rubber sheets 14′ and 16′ proceeds to integrate the uncrosslinked rubber sheets 14′ and 16′ and combine the uncrosslinked rubber sheets 14′ and 16′ with the fiber member layer 15, the core wire 17, and the backface reinforcing fabric 13. Finally, a cylindrical belt slab S is molded. The molding temperature of the belt slab S is, for example, not lower than 100° C. and not higher than 180° C., the molding pressure of the belt slab S is, for example, not lower than 0.5 MPa and not higher than 2.0 MPa, and the molding time of the belt slab S is, for example, not shorter than 10 minutes and not longer than 60 minutes.

Then, the high-pressure air is removed from between the drum body 32a and the expansion sleeve 32b of the expansion drum 32. Then, the belt slab S molded on the inner peripheral surface of the cylindrical mold 33 is taken out, the belt slab S is cut into round slices each having a predetermined number of V-shaped ribs 18, and each round slice is turned inside out, whereby the V-ribbed belt B is obtained.

The above-described void ratio of the surface layer portion K of the compression rubber layer 11 is controlled by adjusting the stretching ratio of the fiber member layer 15 and the molding pressure. The stretching ratio of the fiber member layer 15 is adjusted by stretching the fiber member layer 15 in the height direction or the circumferential direction of the cylindrical mold 33. The stretching ratio is represented by the ratio of the width of the fiber member layer 15 after stretching to the width or circumference of the fiber member layer 15 before stretching.

Although the embodiment of the V-ribbed belt has been described above as the friction transmission belt according to the embodiment of the present invention, the friction transmission belt according to the embodiment of the present invention is not limited thereto, and may be a V-belt, a flat belt, or the like.

### EXAMPLES

Hereinafter, the present invention will be more specifically described by means of examples, but the present invention is not limited to the examples below.

Here, V-ribbed belts of Examples 1 to 6 and Comparative Example 1 were produced and evaluated.

### <Material for Forming Fiber Member Layer>

For forming a fiber member layer, the following three types of knitted fabrics were prepared without performing an adhesion treatment.

(Knitted fabric A) Circular knitted fabric knitted with a knitting yarn made of a cotton fiber and a polyurethane fiber.

(Knitted fabric B) Circular knitted fabric knitted with a knitting yarn made of a cotton fiber, a nylon fiber, and a polyurethane fiber.

(Knitted fabric C) Circular knitted fabric knitted with a knitting yarn made of a nylon fiber and a polyurethane fiber.

The proportion of the cellulose-based fiber (cotton fiber) to the fibers forming the fiber member layer was 84% by mass for the knitted fabric A, 47% by mass for the knitted fabric B, and 0% by mass for the knitted fabric C.

### <Materials for Compression Rubber Layer Body and Adhesive Rubber Layer Body>

An uncrosslinked rubber composition obtained by blending rubber compounding ingredients including EPDM and sulfur was kneaded and then rolled with a calendar roll to produce an uncrosslinked rubber sheet for a compression rubber layer body and an uncrosslinked rubber sheet for an adhesive rubber layer body.

### <Material for Core Wire>

As a material for a core wire, a material obtained by preparing a twisted yarn made of a polyester fiber and performing an adhesion treatment of immersing the twisted yarn in an RFL aqueous solution and then heating and drying the twisted yarn, was prepared.

### <Material for Backface Reinforcing Fabric>

As a backface reinforcing fabric, a fabric obtained by performing an adhesion treatment of immersing a woven fabric, for which a cotton-polyester blended yarn is used, in an RFL aqueous solution and then heating and drying the woven fabric, was prepared.

### Example 1

A V-ribbed belt that has the same configuration as described above in the embodiment and in which the knitted fabric A was used as a fiber member layer and the above-described ones were used as a compression rubber layer body material, an adhesive rubber layer body material, a core wire, and a backface reinforcing fabric, was produced by the manufacturing method described with reference to FIG. 5A to FIG. 6C, and was regarded as a V-ribbed belt of Example 1.

In Example 1, the stretching ratio of the fiber member layer was set to 180%, and the molding pressure was set to 0.7 MPa. The void ratio of the surface layer portion of the compression rubber layer was 38%.

### Examples 2 to 4 and Comparative Example 1

V-ribbed belts of Examples 2 to 4 and Comparative Example 1 were produced in the same manner as Example 1, except that the stretching ratio and the molding pressure were set as shown in Table 2 below.

The void ratio of the surface layer portion in each of Examples 2 to 4 and Comparative Example 1 was as shown in Table 2.

### Example 5

A V-ribbed belt of Example 5 was produced in the same manner as Example 1, except that the knitted fabric B was used for the fiber member layer and the stretching ratio and the molding pressure were set as shown in Table 2 below.

In Example 5, the void ratio of the surface layer portion was 22%.

### Example 6

A V-ribbed belt of Example 6 was produced in the same manner as Example 1, except that the knitted fabric C was used for the fiber member layer and the stretching ratio and the molding pressure were set as shown in Table 2 below.

In Example 6, the void ratio of the surface layer portion was 20%.

### <Evaluation of Dynamic Friction Coefficient During Water Exposure>

Using the belt running tester 20 shown in FIG. 2, the relationship between a slipping speed and a friction coefficient was obtained for Examples 1 to 6 and Comparative Example 1 according to the above-described evaluation method, and the decrease rate Dm of the friction coefficient indicated by the above-described equation (1) was obtained. Furthermore, the zone from the first slipping speed V1 to the second slipping speed V2 was equally divided into five sections, and the decrease rate Dsm of the friction coefficient indicated by the above-described equation (2), that is, the decrease rates Ds1, Ds2, Ds3, Ds4, and Ds5, were obtained for the respective sections. The results are shown in Table 2 below.

### <Evaluation of Abnormal Sound During Water Exposure>

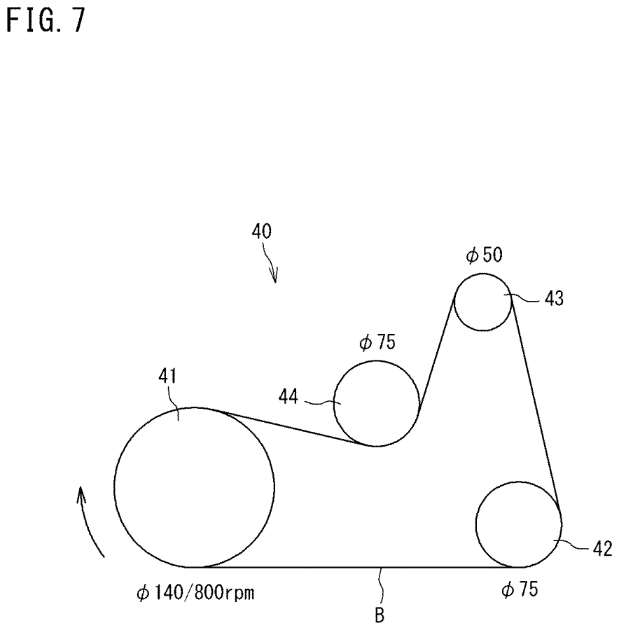

FIG. 7 illustrates a layout of pulleys of a belt running tester 40 for evaluating abnormal sound during water exposure. In FIG. 7, reference sign B denotes a V-ribbed belt.

The belt running tester 40 for evaluating abnormal sound during water exposure includes a driving pulley 41 which is a rib pulley having a pulley diameter of 140 mm, a first driven pulley 42 which is a rib pulley having a pulley diameter of 75 mm is provided on the right side of the driving pulley 41, a second driven pulley 43 which is a rib pulley having a pulley diameter of 50 mm is provided above the first driven pulley 42 and obliquely upward on the right side of the driving pulley 41, and an idler pulley 44 which is a flat pulley having a pulley diameter of 75 mm is provided at the middle between the driving pulley 41 and the second driven pulley 43. The belt running tester 40 for evaluating abnormal sound during water exposure is configured such that the V-ribbed belt is trained around the pulleys such that the V-shaped rib side of the V-ribbed belt is in contact with the driving pulley 41 and the first and second driven pulleys 42 and 43, which are rib pulleys, and the backface side of the V-ribbed belt is in contact with the idler pulley 44 which is a flat pulley.

The V-ribbed belt of each of Examples 1 to 6 and Comparative Example 1 was set to the belt running tester 40 for evaluating abnormal sound during water exposure, and pulley positioning was performed such that a belt tension of 49 N per rib was applied. Resistance was applied to the second driven pulley 43 such that a current of 60 A flowed in an alternator to which the second driven pulley 43 was attached, the driving pulley 41 was rotated at a rotational speed of 800 rpm at room temperature, and water was dropped on the V-shaped rib side of the V-ribbed belt at a rate of 1000 ml per minute at an approach portion of the V-ribbed belt to the driving pulley 41. Then, the abnormal sound generation state during belt running was evaluated on the following five-level scale: “S: generation of abnormal sound is not recognized at all; A: generation of abnormal sound is faintly recognized; B: generation of abnormal sound is slightly recognized; C: generation of abnormal sound is clearly recognized; and D: generation of intense abnormal sound is recognized.”

TABLE 2

| | | | | | Comparative | | |
|---|---|---|---|---|---|---|---|
| | Example 1 | Example 2 | Example 3 | Example 4 | Example 1 | Example 5 | Example 6 |
| Stretching ratio | 180 | 180 | 230 | 240 | 260 | 180 | 180 |
| [%] | | | | | | | |
| Pressure [MPa] | 0.7 | 1.4 | 1.4 | 1.4 | 1.4 | 1.4 | 1.4 |
| Fiber member | Knitted | Knitted | Knitted | Knitted | Knitted | Knitted | Knitted |
| layer | fabric A | fabric A | fabric A | fabric A | fabric A | fabric B | fabric C |
| Void ratio [%] | 38 | 23 | 12 | 10 | 6 | 22 | 20 |
| Dm [%] | 8.6 | 14.6 | 19.8 | 19.9 | 26.6 | 16.2 | 17.1 |
| Ds1 [%] | 1.4 | 3.2 | 4.0 | 5.2 | 6.0 | 3.5 | 3.2 |
| Ds2 [%] | 1.7 | 2.8 | 3.9 | 4.1 | 5.8 | 3.4 | 3.8 |
| Ds3 [%] | 1.8 | 2.8 | 4.0 | 3.9 | 5.2 | 3.1 | 3.3 |
| Ds4 [%] | 1.9 | 2.8 | 3.9 | 3.3 | 4.6 | 3.2 | 3.4 |
| Ds5 [%] | 1.8 | 2.9 | 3.9 | 3.4 | 5.0 | 3.1 | 3.5 |
| Generation of | S | S | B | C | D | S | A |
| abnormal | | | | | | | |
| sound | | | | | | | |

As shown in Table 2, in the V-ribbed belt according to the embodiment of the present invention, a decrease in the friction coefficient is suppressed, and a reduction in abnormal sound generated during water exposure is achieved.

Moreover, it is also confirmed that when the void ratio of the surface layer portion of the compression rubber layer is larger, the decrease rate of the friction coefficient can be reduced to be smaller.

### INDUSTRIAL APPLICABILITY

The V-ribbed belt according to the present disclosure is useful, for example, for an auxiliary mechanism driving belt transmission device of an automobile, and the like.

### REFERENCE SIGNS LIST

10 belt body
11 compression rubber layer
12 adhesive rubber layer
13 backface reinforcing fabric
14 rubber layer body (compression rubber layer body)
14a V-shaped rib body
15 fiber member layer
16 adhesive rubber layer body
17 core wire
18 V-shaped rib
20, 40 running tester
30 crosslinking device
14′, 16′ uncrosslinked rubber sheet
B friction transmission belt (V-ribbed belt)
K surface layer portion

1. A friction transmission belt comprising a belt body which transmits power to a pulley by a frictional force generated when coming into contact with the pulley, wherein
in a relationship between a friction coefficient and a slipping speed which is a difference between a speed of the belt body and a speed of the pulley, when a slipping speed at which a maximum friction coefficient is indicated is defined as a first slipping speed, a friction coefficient when the slipping speed is increased from the first slipping speed to a second slipping speed is defined as a reference friction coefficient, and a difference between the second slipping speed and the first slipping speed is 500 mm/s,
a decrease rate Dm of the friction coefficient indicated by the following equation (1) with the maximum friction coefficient being denoted by μx and the reference friction coefficient being denoted by μr is not greater than 20%,
Dm=(μx−μr)/μx×100 (1).

2. The friction transmission belt according to claim 1, wherein
when a zone from the first slipping speed to the second slipping speed is equally divided into n sections (n is a natural number of 2 or more), a slipping speed at start of each section is defined as a start speed, a friction coefficient at the start speed is defined as a start friction coefficient, a slipping speed at end of the section is defined as an end speed, and a friction coefficient at the end speed is defined as an end friction coefficient,
a decrease rate Dsm of the friction coefficient indicated by the following equation (2) with the start friction coefficient and the end friction coefficient in an mth section (m is a natural number of not less than 1 and not greater than n) being denoted by μsm and μem, respectively, is not greater than 20/n % in all the sections,
Dsm=(μsm−μem)/μsm×100 (2).

3. The friction transmission belt according to claim 1, wherein
the belt body includes a compression rubber layer which comes into contact with the pulley, and
the compression rubber layer includes a rubber layer body formed from a rubber composition, and a fiber member layer stacked on the rubber layer body.

4. The friction transmission belt according to claim 3, wherein a void ratio of a surface layer portion of the compression rubber layer is not less than 10%.

5. The friction transmission belt according to claim 4, wherein the void ratio is not less than 20%.

6. The friction transmission belt according to claim 4, wherein
the fiber member layer is formed from a knitted fabric, and
the knitted fabric contains a cellulose-based fiber as a main fiber.

7. The friction transmission belt according to claim 6, wherein a plurality of V-shaped ribs are formed in the compression rubber layer so as to project on an inner peripheral side.

8. The friction transmission belt according to claim 5, wherein
the fiber member layer is formed from a knitted fabric, and
the knitted fabric contains a cellulose-based fiber as a main fiber.

9. The friction transmission belt according to claim 8, wherein a plurality of V-shaped ribs are formed in the compression rubber layer so as to project on an inner peripheral side.

10. The friction transmission belt according to claim 2, wherein
the belt body includes a compression rubber layer which comes into contact with the pulley, and
the compression rubber layer includes a rubber layer body formed from a rubber composition, and a fiber member layer stacked on the rubber layer body.

11. The friction transmission belt according to claim 10, wherein a void ratio of a surface layer portion of the compression rubber layer is not less than 10%.

12. The friction transmission belt according to claim 11, wherein the void ratio is not less than 20%.

13. The friction transmission belt according to claim 11, wherein
the fiber member layer is formed from a knitted fabric, and
the knitted fabric contains a cellulose-based fiber as a main fiber.

14. The friction transmission belt according to claim 13, wherein a plurality of V-shaped ribs are formed in the compression rubber layer so as to project on an inner peripheral side.

15. The friction transmission belt according to claim 12, wherein
the fiber member layer is formed from a knitted fabric, and
the knitted fabric contains a cellulose-based fiber as a main fiber.

16. The friction transmission belt according to claim 15, wherein a plurality of V-shaped ribs are formed in the compression rubber layer so as to project on an inner peripheral side.
